(19) United States
(12) Patent Application Publication
(10) Pub. No.: US 2015/0343662 A1
(43) Pub. Date: Dec. 3, 2015

(54) TABLE SAWS HAVING INTEGRATED CONTROL SYSTEMS

(71) Applicant: Black & Decker Inc., Newark, DE (US)

(72) Inventors: Joshua J. Aiken, Eldersburg, MD (US); Ross A. Billings, Reisterstown, MD (US); Peter Chaikowsky, Forest Hill, MD (US)

(21) Appl. No.: 14/708,579

(22) Filed: May 11, 2015

Related U.S. Application Data
(60) Provisional application No. 62/004,399, filed on May 29, 2014.

(51) Int. Cl. B27G 19/02; B26D 5/08; B27G 19/08; B23D 45/06

(52) U.S. Cl. CPC B27G 19/02; B23D 45/061; B26D 5/08; B27G 19/08

(57) ABSTRACT

A table saw has a table, a motor disposed under the table, a carriage connected to the motor, a saw blade supported by the carriage and driven by the motor, a riving knife connectable to the carriage adjacent to the saw blade, and a control circuit for determining when the riving knife is connected to the carriage, the control circuit receiving input from a switch which is engaged when the riving knife is disposed on the carriage. A switch contactor disposed on the carriage may contact the switch when the riving knife contacts the switch contactor.

### CROSS-REFERENCE TO RELATED APPLICATION

The following application derives priority from US patent application Ser. No. 62/004,399, filed on May 29, 2014, now pending, which is hereby incorporated in whole by reference.

### FIELD

The present invention generally relates to power saws, and more specifically relates to table saws having integrated control systems.

### BACKGROUND

Table saws typically include a base or frame that supports a table having a planar top surface. The table generally includes a slot through which a cutting member, such as a circular saw blade, protrudes above the top surface of the table. Most table saws have a splitter that is mounted in alignment with a trailing end of the saw blade. When cutting a workpiece, the splitter maintains the two portions of the workpiece that have been cut spaced from one another to reduce the possibility of workpiece kickback. Many conventional table saws also include top guards and side guards that protect the operator from injury caused by accidental contact with a rotating saw blade. In some instances, the splitter, the top guards, and/or the side guards may be removed to make certain types of cuts, such as non-through cuts.

There have been many efforts seeking to encourage operators to leave guarding in place or to place guarding back on table saws after specific projects requiring their temporary removal have been completed. For example, in one embodiment, commonly assigned U.S. Patent Application Publication No. 2007/0163408, the disclosure of which is hereby incorporated by reference herein, discloses a table saw guard that enables the guard to be removed and reattached without the use of tools. The table saw guard includes a riving knife and guard assembly that provides a clear view of the work zone, blade and work piece, and is easily adjustable to accommodate different size workpieces and cutting angles. In one embodiment, the riving knife extends upwardly from the table and is substantially coplanar with the saw blade, and the guard assembly is releasably attached to an upper end of the riving knife using a rotatable latch.

In some instances, it may be advisable to automatically shut down a table saw if the guard has been removed. In one embodiment, commonly assigned U.S. Pat. No. 6,418,829, the disclosure of which is hereby incorporated by reference herein, teaches a control device for a power tool including a protective guard provided over a cutting blade that prevents the use of the power tool when the protective guard is not in place. The control device includes a proximity detector that detects a distance between the guard and a table top, and an interlock system that prevents operation of the power tool when a distance less than a predetermined relative proximity is not detected. A pair of magnets is secured to the guard and a pair of reed switches is mounted beneath the table top. The reed switches are closed when the guard is in place. The interlock system allows the saw to be started when the reed switches are both closed and prevents start up when the reed switches are open. When the guard is not present the saw motor may be started using a key-activated bypass circuit.

In spite of the above advances, there remains a need for mechanical guard assemblies for table saws that protect users from accidentally contacting rotating saw blades during operation, while providing users with a sufficient viewing area of the cutting zone between the workpiece and the saw blade. Moreover, there remains a need for table saws having integrated control systems that are may not be easily overridden, bypassed, or fooled by an operator.

### SUMMARY

A table saw with a table, a motor disposed under the table, a carriage connected to the motor, a saw blade supported by the carriage and driven by the motor, a riving knife connectable to the carriage adjacent to the saw blade, and a control circuit for determining when the riving knife is connected to the carriage, the control circuit receiving input from a switch which is engaged when the riving knife is disposed on the carriage. A switch contactor disposed on the carriage may contact the switch when the riving knife contacts the switch contactor.

### BRIEF DESCRIPTION OF THE DRAWINGS

FIG. 1 shows a perspective view of a table saw having an integrated guard system, in accordance with one embodiment of the present invention.

FIG. 2 shows a schematic view of a circuit for integrating a guard assembly into a table saw, in accordance with one embodiment of the present invention.

FIG. 3 shows a right hand perspective view of portions of the guard assembly.

FIGS. 4A-4B show a right hand perspective view of the guard assembly and the carriage, where FIGS. 4A-4B show the guard assembly disconnected from the carriage and connected to the carriage, respectively.

FIG. 5 shows a left hand perspective view of portions of the carriage.

### DETAILED DESCRIPTION

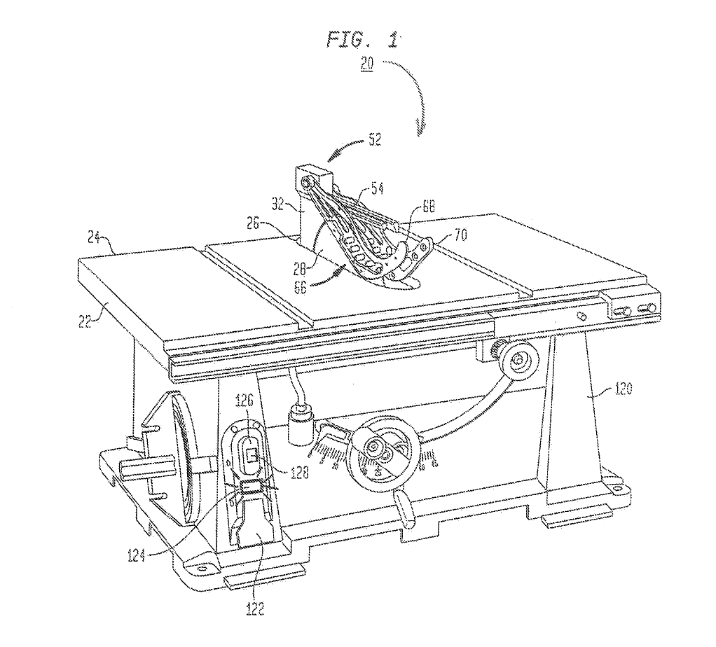

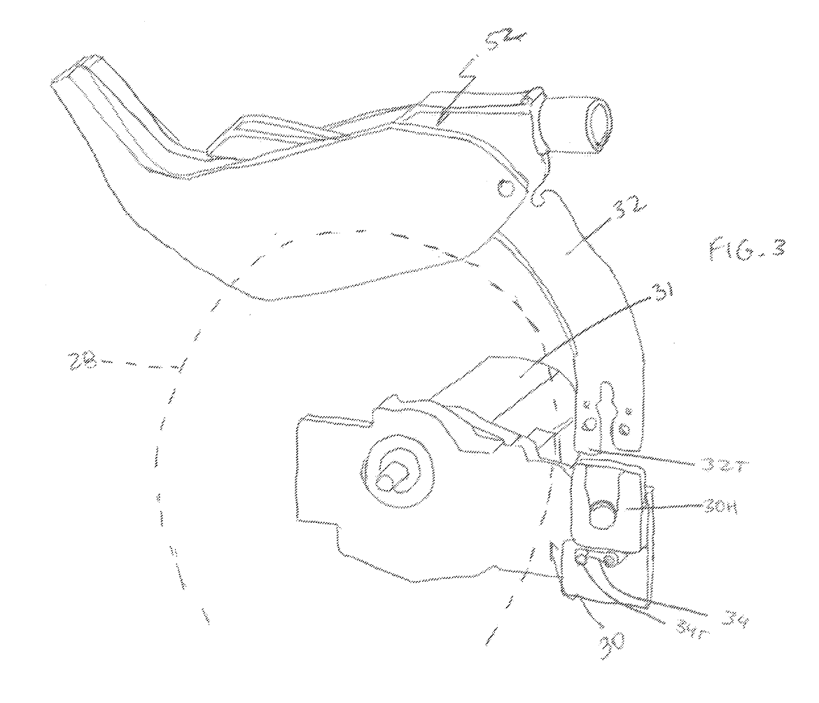

Referring to FIGS. 1 and 3, a table saw 20 preferably includes a table 22 with a top surface 24 adapted to support a workpiece during a cutting operation. The table 22 desirably includes an aperture 26 that extends through the table 22 and a rotatable saw blade 28 that projects through the aperture for cutting a workpiece. The saw blade 28 is preferably coupled with a motor 31 and a carriage 30 that are preferably located below the table 22.

The table saw 20 preferably includes a splitter 32 that extends through the aperture 26 and projects upwardly from the top surface 24 of the table 22. In one embodiment, the splitter 32 is preferably formed from a flat plate that extends through the aperture 26 in the table 22. A lower end of the splitter 32 may be mounted to the carriage 30 of the table saw 20 so that it is aligned with the saw blade 28. In one embodiment, the splitter 32 is desirably mounted on the carriage 30 for movement in conjunction with the saw blade 28. Persons skilled in the art can obtain further information on how the splitter 32 is mounted on carriage 30 from US Patent Publication No. 2010/0257990, filed on Sep. 17, 2009, entitled “Table Saws Having Integrated Control Systems,” which is hereby fully incorporated by reference.

The table saw 20 desirably includes a guard assembly 52 that is attachable to the splitter 32 to prevent an operator from contacting the saw blade 28 during a cutting operation. The guard assembly 52 may include a top guard 54 attachable to the upper end of the splitter 32.

The guard assembly 52 also preferably includes a side guard 66 that is pivotably mounted to the top guard 54. The side guard 66 desirably provides a protective surface that surrounds the front and the sides of the exposed portion of the saw blade 28. The side guard 66 preferably has a left arm 68 and a right arm 70, each extending beyond the fingers of the top guard 54. The left and right arms 68, 70 desirably provide protection from the saw blade 28.

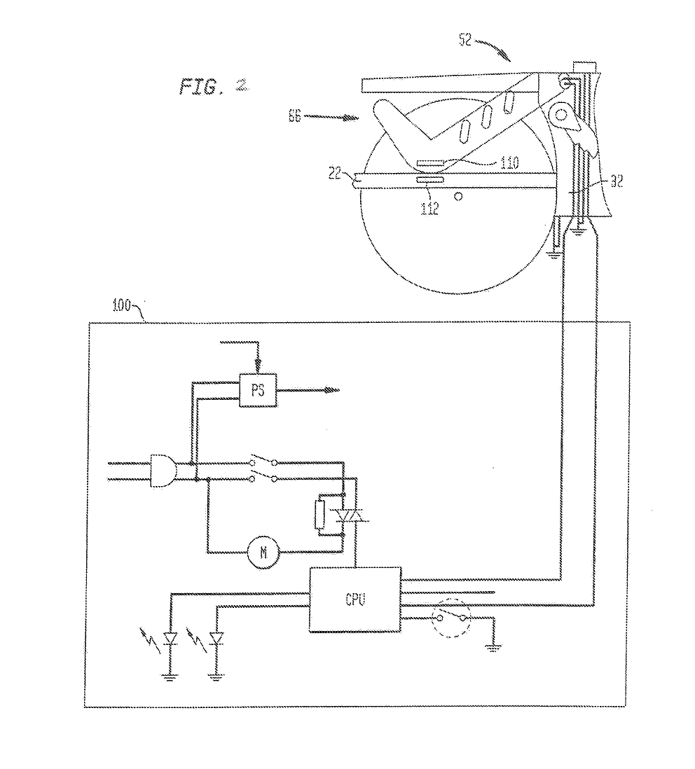

Referring to FIG. 2, a control system 100 is preferably interconnected with the riving knife 32 and the guard assembly 52 including the top guard 54 and the side guard 66. The control system 100 desirably forms a control circuit that determines if the riving knife 32 and the guard assembly 52 are properly assembled over the saw blade 28 and/or connected to carriage 30. If the guard assembly 52 or the riving knife 32 are not in place or properly secured atop the table saw 20, or if the side guard 66 is elevated before starting the table saw (and/or if the guard assembly 52 or the riving knife 32 are correctly in place and properly secured atop the table saw 20), the control system will desirably recognize the deficiency and generate appropriate response signals as described in US Patent Publication No. 2010/0257990, filed on Sep. 17, 2009, entitled “Table Saws Having Integrated Control Systems,” which is hereby fully incorporated by reference.

Referring to FIGS. 3-5, persons skilled in the art will recognize that it is preferable to provide carriage 30 with a holder 30H which slidably receives riving knife 32 therein. Riving knife 32 may have a tab 32T which preferably extends through and beyond holder 30H.

A switch contactor 34 may be pivotally attached to carriage 30 via pivot 34P. Switch contactor 34 preferably extends through holder 30. Persons skilled in the art will recognize that switch contactor 34 may have portions on both sides of holder 30.

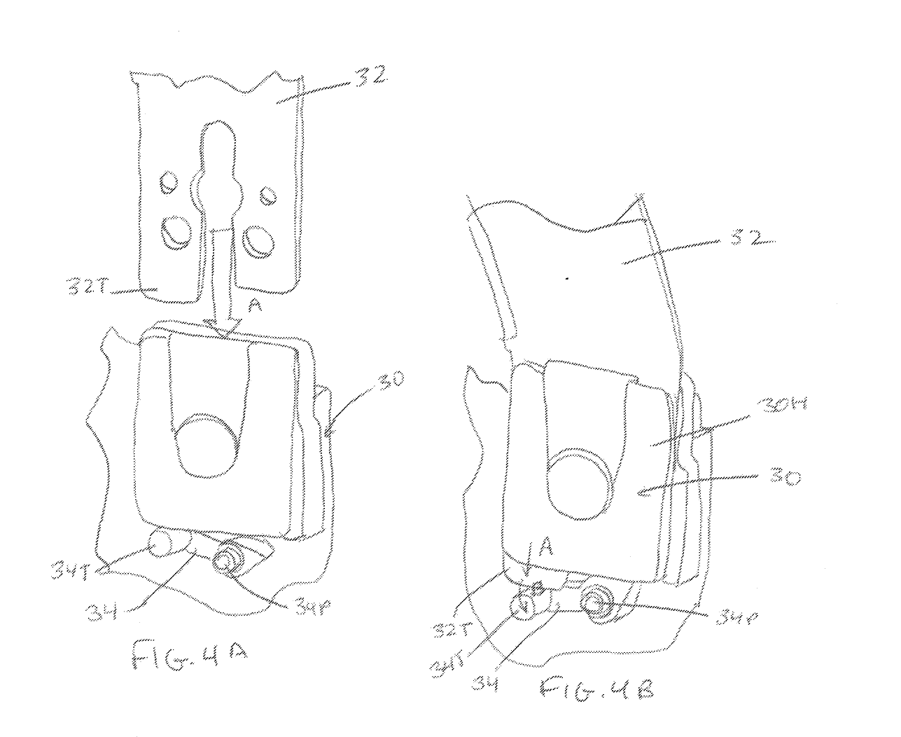

On one side of carriage 30, switch contactor 34 may have a protrusion 34T which contacts tab 32T when riving knife 32 is inserted into holder 30H along direction A (FIG. 4A). When tab 32T contacts protrusion 34T, switch contactor 34 rotates about pivot 34P along direction B (FIG. 4B).

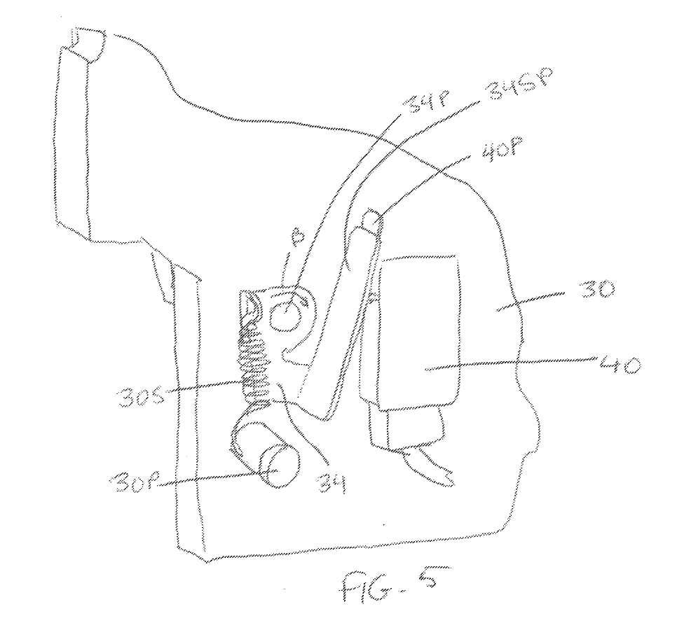

On the other side of carriage 30 (and the side opposite of protrusion 34T), switch contactor 34 may have a paddle 34SP which contacts the switch paddle 40P of detector switch 40 when switch contactor 34 is rotated along direction B (FIG. 5).

A spring 30S may be connected to switch contactor 34 at one end and to a post 30P at the other end. Preferably spring 30S biases switch contactor to a non-contacting position where protrusion 34T is not contacting tab 32T as shown in FIG. 4A. Persons skilled in the art will recognize that, in such position, paddle 34SP does not contact switch paddle 40P, and thus control system 100 does not detect riving knife 32 properly disposed on carriage 30.

Persons skilled in the art will recognize that it is preferable to design the geometry of switch contactor 34 so that paddle 34SP will not contact switch paddle 40P until riving knife 32 has been moved to a position within carriage 30 where it can be locked properly. Preferably paddle 34SP is resilient so that, if riving knife 32 and/or switch contactor 34 move too far beyond a point, paddle 34SP will deflect so that it does not overstress detector switch 40.

Persons skilled in the art may recognize other additions or alternatives to the means disclosed herein. All these additions and/or alterations are considered to be equivalents of the present invention.

What is claimed is:

1: A table saw comprising:
a table,
a motor disposed under the table,
a carriage connected to the motor, a saw blade supported by the carriage and driven by the motor,
a riving knife connectable to the carriage adjacent to the saw blade,
a control circuit for determining when the riving knife is connected to the carriage, the control circuit receiving input from a switch which is engaged when the riving knife is disposed on the carriage, and
a switch contactor disposed on the carriage contacting the switch when the riving knife contacts the switch contactor.

2: The table saw of claim 1, wherein the switch contactor is pivotally attached to the carriage.

3: The table saw of claim 2, wherein the riving knife has a tab that contacts the switch contactor when the riving knife is disposed on the carriage.

4: The table saw of claim 3, wherein the tab contacts a protrusion of the switch contactor.

5: The table saw of claim 4, wherein the switch contactor has a paddle for contacting the switch.

6: The table saw of claim 5, wherein the protrusion is adjacent to one side of the riving knife, and the paddle is adjacent to another side of the riving knife.

7: The table saw of claim 5, further comprising a spring connected to the switch contactor for biasing the paddle away from the switch contactor.

8: The table saw of claim 1, further comprising a blade guard disposed on the riving knife.

9: The table saw of claim 1, wherein the riving knife has a tab that contacts the switch contactor when the riving knife is disposed on the carriage.
